(19) United States
(12) Patent Application Publication
(10) Pub. No.: US 2003/0232141 A1
(43) Pub. Date: Dec. 18, 2003

(54) Tarnish-resistant coating for heat sensitive metallic substrates, method of manufacture, and articles produced thereby

(76) Inventors: Karl R. Wursthorn, Mohnton, PA (US); Andrew T. Daly, Sinking Springs, PA (US); Eugene P. Reinheimer, Wyomissing, PA (US); Michael L. Spera, Mohnton, PA (US)

Correspondence Address: ROHM AND HAAS COMPANY, PATENT DEPARTMENT, 100 INDEPENDENCE MALL WEST, PHILADELPHIA, PA, 19106-2399, US

(21) Appl. No.: 10/439,946

(22) Filed: May 16, 2003

Related U.S. Application Data
(60) Provisional application No. 60/388,902, filed on Jun. 14, 2002.

(51) Int. Cl. B05D 3/00; B05D 1/36; B05D 7/00

(52) U.S. Cl. 427/299; 427/402

(57) ABSTRACT

A method for improving the tarnish-resistance and adhesion characteristics of temperature-sensitive substrate metals is provided as well as composite materials including the improved substrates. The temperature-sensitive metal substrate is coated with an intermediate layer of a polyalkyleneimine, heated to polymerize the imine, and then coated with an epoxy containing powder coating.

### BACKGROUND

This disclosure generally relates to tarnish-resistant coatings for heat-sensitive metallic substrates, used in combination with powder coatings.

Temperature-sensitive metals such as, for example, brass and aluminum, frequently exhibit tarnish when they are heated to high temperatures. For example, brass is a widely used material of construction for many articles of commerce. Parts formed from brass generally require a clear coat finish to enhance their luster and appearance and achieve protection against wear or the environment. Good adhesion of the finish coat of the substrate is also a requirement.

Fusion-bonded, thermosetting coating powder compositions have been used to coat temperature-sensitive metals. Coating powders are dry, finely divided, free-flowing solid materials at room temperature. Upon application to a surface, they are heated to fuse and optionally cure, thereby forming a powder coating. Coating powders are conveniently applied using electrostatic methods, wherein an electric potential is generated between the coating powder and the substrate to be coated, causing the powder particles to be attracted to the substrate. Coating powders offer a number of advantages over liquid coatings. For instance, corrosion and scratch resistance is much superior to that of liquid coatings. In addition, coating powders are virtually free of the harmful fugitive organic solvents normally present in liquid coatings and, accordingly, give off little, if any, volatiles during curing, which eliminates solvent emission problems and dangers to the health of workers employed in coating operations.

Because many temperature-sensitive metals, for example, brass, tend to discolor or tarnish at higher temperatures, thermosetting powder coatings exhibiting good adhesion that are capable of curing at low temperatures, e.g., below about 350° F., (176.7° C.) are preferred. Low cure temperatures are also desired. Even at these relatively low temperatures, many of these metals still tarnish. Accordingly, a method of improving adhesion of the finish coat, which also reduces or substantially eliminates tarnishing of the substrate is desirable.

### STATEMENT OF THE INVENTION

In one embodiment, a method is provided for improving the adhesion of powder coatings on a metallic substrate, the method comprising: applying a polyalkyleneimine to a surface of the substrate to form an intermediate layer on the substrate; disposing a layer of a coating powder composition on at least a portion of the intermediate layer; and heating the coating powder to fuse and cure the coating powder, thereby forming a powder coating on the substrate.

In yet another embodiment, an article is provided comprising a composite structure, which comprises, in intimate adhesive contact, a metallic substrate; an adhesion promoting layer comprising a polyalkylene imine disposed on the metallic substrate; and a powder coating disposed at least partially on the adhesion promoting polyalkyleneimine layer.

### DETAILED DESCRIPTION

Use of the selected polyalkyleneimine coatings to form an adhesive layer on cleaned, temperature-sensitive metallic substrates not only improves tarnish resistance of the substrate, but also improves adhesion of subsequent powder coatings to the substrate. The composite materials thus formed are tarnish-resistant and a good adhesive bond with applied powder coatings.

The metallic substrate to be treated is any metal or combination of metals, although the invention is of particular utility with tarnish-susceptible and/or heat-sensitive metals. Other materials in combination with metal may be used, for example, wood (including engineered wood such as particle board) or plastic (for example ABS). Suitable metals and metal alloys include brass, nickel, copper, tin, lead, aluminum, zinc, magnesium, as well as precious metals such as gold, silver, and platinum. Tarnish-susceptible metal substrates including particulate powdered metals having a smooth, water impermeable non-porous surface to which top coating materials adhere with difficulty are included. These particularly include substrate materials which are flexible and subject to scraping and denting, such as, for example, bright cold rolled metals, clod metals, electroplated metals, drawn metal wire, metal foils, powdered metals such as brass and aluminum used for pigments, and the like.

Advantageously, the metal substrate is chemically or mechanically cleaned prior to application of an intermediate coating, typically by a chemical/water solution to remove the metal surface contaminates. The surface is then preferably rinsed with water or water chemical rinsing solution combinations. Excess water/chemical solution is removed. Then, in some cases, an optional chemical pretreatment is employed, usually a heated solution.

This optional chemical pretreatment solution may be applied to react with and modify the metal surface to produce a surface suitable for coating, to enhance coating adhesion and to provide for corrosion resistance. The metal substrate is then given a final rinse and is dried.

It has been found that a deposit of an organic polyalkyleneimine which has the basic chain structure of a polyalkyleneimine, such as, for example, polyethyleneimine, i.e., having repeating units of —C—C—N—, either substituted or unsubstituted, connected end-to-end to form the chain, interposed between a substrate and a powder coating thereon, particularly an epoxy powder coating, improves adhesion and tarnish-resistance and has many process advantages. The organic polyimines useful are described herein as polyalkyleneimines in view of the repeating alkylene chain units interconnected by nitrogen.

Selected polyalkyleneimines have been used to assist in heat sealing laminates of metal foil and polyolefins in U.S. Pat. No. 3,140,196 and paper and polyethylene laminates in U.S. Pat. No. 3,230,135. Polyethyleneimine-based materials have been used as a dispersion aid for titanium dioxide pigments in U.S. Pat. No. 3,425,855. In U.S. Pat. No. 2,887,405, selected resinous organic nitrogen polymers have been used in less than a monomolecular layer, to improve adhesion between a topcoat and a substrate. Preferably, 15% of the substrate has no resinous polymeric coating. The art, however, does not recognize that temperature-sensitive metals both in solid and powder form obtains both an improved adhesion and reduced tarnishing when fully coated with selected polyimines and then top coated with powder coatings.

Suitable polyalkyleneimines are of a character so that when applied in a proper amount they provide a bond substantially equivalent to the bond provided by polyethyleneimine or polypropyleneimine applied in an amount of 0.001 to 1.0 kilogram per 100 square meters of substrate preferably 0.001 to 0.1 kilogram per 100 square meters. The amount deposited should be sufficient to produce a coating of 0.01 to 2 mil (0.254 to 50.8 micrometers) thickness, preferably 0.1 to 1.5 mil (2.54 to 38.1 micrometers) and, most preferably, 0.2 to 1.0 mil (5.08 to 25.4 micrometers) thickness.

Polyethyleneimine is one of a family of polyalkyleneimines, including substituted polyalkyleneimines, which are useful herein. The monomeric structural unit formula for the polyalkyleneimine is as follows:

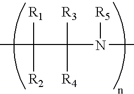

wherein R₁ through R₄ are each selected from the class consisting of hydrogen and lower alkyl groups, R₅ is selected from the class consisting of hydrogen, lower alkyl groups, hydroxy substituted lower alkyl groups, lower alkyl alkoxy groups, and fatty acid residue from the reaction of a fatty acid with the imine and n is a whole number. The polyalkyleneimines include the quaternary ammonium compounds and salts of the above imine, e.g., quaternary chlorides, sulfates, nitrates, acetates, etc. The preferred polyalkyleneimines are polyethyleneimine, polypropyleneimine, and copolymers of polyethyleneimine and polypropyleneimine. Polyethyleneimine is useful and commercially available. A commercially available polyethyleneimine known as Polymin P, made by BASF., and a commercially available polyethyleneimine known as LUPASOL® PL from BASF have proved very satisfactory. Other polyethyleneimines of varying molecular weights are satisfactory. However, the very low molecular weight polyethyleneimines, such as below about 2000, do not exhibit adhesive properties sufficient to provide the improvement of the invention. Compositions having molecular weights in excess of 2000 up to the point where they become so highly viscous as to become unmanageable, are contemplated. Other polyimines, even when such polyimines have lower molecular weights of about 800 or below, are useful. These wide ranges of compositions are all useful.

Since polyalkyleneimines tend to be viscous at room temperature, it is preferred to dilute them to a solids content such as, for example 1.5% by weight, which is easier to handle. Water is suitable, or volatile monohydroxy alcohols may be used, for example normally liquid nonoily alcohols which boil below about 250° C., for example, methyl alcohol, ethyl alcohol, propyl alcohol, isopropyl alcohol, butyl alcohol, isobutyl alcohol, amyl alcohol, hexyl alcohol, benzyl alcohol, and the like. Mixtures of water and such alcohols are also suitable.

Where it is desirable to use a composition having a somewhat greater viscosity than the 1.5% by weight solids content mentioned above with regard to a dilute polyethyleneimine solution, it is advantageous to prepare a composition to contain a higher polymer content such as, for example, 9% polyethyleneimine by weight and to add a small amount, such as 1% to 5% by weight, of a suitable filler or thickener such as, for example, carboxymethyl cellulose, polyvinyl alcohol, methyl cellulose, starch, and the like. This composition is preferably then further diluted to a concentration of about 1.5% by weight of the polyethyleneimine, dry basis, to provide a composition at a standardized concentration for convenience in application to the substrate. The substrate is preferably coated with a solution containing the imine followed by drying the substrate. This solution is preferably an aqueous solution containing very little, if any, volatile organics. This solution preferably contains about 1.5% polyimine by weight.

The solution may contain between about 0.01% to 5% by weight of the polymer as needed to deposit a sufficient amount on the surface to be treated. An intermediate amount, e.g., between about 0.1% to 2% by weight of the agent, is generally sufficient at contact times between 15 seconds and 5 minutes. The solution may be applied simply by contacting the substrate therewith, e.g., by dipping, spraying, roller coating, or brushing. Good results are obtained when the contact time is of the order of 3-5 seconds. Longer contact times may be used but in most instances are generally unnecessary.

It is possible to apply a layer of the polyimine agent of suitable thinness by dipping the substrate into a dispersion or solution of the polyimine agent of predetermined strength for a predetermined time and then removing and drying the substrate, so that selected amounts are adsorbed. It is also possible, however, to immerse the substrate in a somewhat stronger solution of the polyimine and then to remove any excess agent present by washing the substrate with water. In its preferred embodiment, the invention comprises the method of applying, by roll coating, spraying, dipping, and the like, a coating of polyimine to the cleaned substrate. In the case of particulate or powdered substrate, a slurry may be used. By this method, it is possible not only to obtain a better top or final coat bond than is obtainable under present accepted operating conditions, but it is even possible to obtain a satisfactory bond under conditions which heretofore would not have produced a satisfactory bond. The polyimine is applied at a rate sufficient to deposit on the surface of the substrate from 0.001 to 1.0 kilogram, dry basis, of polyimine per 100 square meters of substrate.

While significant anchoring takes place when the concentration of intermediate in the treating solution was very low, best anchoring occurred when the concentration of the polyethylenimine in the solution was about 1.0% by weight. Additional amounts may be used, but were not observed to significantly increase adhesion.

The amount of intermediate polyimine agent applied according to preferred embodiments of the present invention should not be confused with coatings applied for decorative or protective purposes. Coatings are generally at least about 3.5 mils (88.9 micrometers) thick when applied for protective purposes. In distinction, the amount of intermediate agent preferably present according to the present invention is sufficiently small that the agent is nearly or completely invisible on metals such as polished brass, aluminum, gold, and platinum.

It is usually advantageous to remove the solvent, i.e., to dry the substrate following application of the intermediate polyimine agent. This is accomplished by evaporation at room temperature or under a vacuum, for example, or by heating the coated substrate to a temperature of about 200° F. (93° C.) to 500° F. (260° C.), preferably about 300° F. (149° C.) to 450° F. (232° C.)and, most preferably, to avoid substrate degradation to a temperature of about 350° F. (177° C.)to 400° F. (204° C.). The length of time is sufficient to drive off the water or other solvent. Depending on the degree of crosslinking of the polyalkyleneimine, heating may function to further polymerize the intermediate coating. Suitable times when heating are usually about 5 to 15 minutes, preferably 8 to 12 minutes and, most preferably about 10 to 12 minutes.

The substrate is then coated with a coating powder composition, preferably an epoxy containing coating powder. Such coating powders known. For coating powders to be used at relatively low temperatures, such as for coating heat-sensitive metals, it is preferred to use as the epoxy resin, epoxy-functional acrylic resins, such as glycidyl methacrylate copolymer (GMA resins). Epoxy equivalent weights of such polymers should range from about 200 to about 1000, preferably between about 200 and about 600. Weight average molecular weights of such epoxy functional acrylic polymers is between about 200 and about 2000; T_{g} s range between about 40 and about 60° C., and softening points range between about 55 and about 75° C.

Glycidyl esters of aromatic and aliphatic polyacids include glycidyl esters of such polyacids as, for example, terephthalic acid, isophthalic acid, phthalic acid, methylterephthalic acid, trimellitic acid, pyromellitic, and methylhexahydrophthalic acid. These monomers may be co-polymerized with other α,β-ethylenically unsaturated monomers mentioned above with respect to carboxylic acid functional acrylic resins.

Suitable polyepoxy compounds as curatives B) include heterocyclic polyepoxides such as triglycidylisocyanurate (TGIC); polyepoxides of aromatic polyols such as the diglycidyl ether of bisphenol A; cycloaliphatic polyepoxides; glycidyl esters of aromatic or aliphatic polyacids, such as the diglycidyl ester of hexahydrophthalic acid; low equivalent weight epoxy-functional acrylic resins; polyepoxides of aliphatic polyols such as the diglycidyl ether of 1,4-butanediol; and polyepoxides of amino-alcohols, such as the tri-glycidyl ether-amine of 4-amino phenol. Other aromatic polyols which may be used to prepare glycidyl ethers include such species as bisphenol F, and tetrabromobisphenol A, and the like. Polyepoxides from this category also include low molecular weight polymers derived from the above-named aromatic diols and their diglycidyl ethers. Cycloaliphatic polyepoxides include such compounds as 3′, 4′-epoxycyclohexylmethyl-3,4-epoxycyclohexyl carboxylate and dicyclopentadiene dioxide, and the like.

Epoxies used in the invention have epoxy functionalities of at least two, preferably at least about 3, up to 16. Epoxies useful in coating powder compositions should be solid at room temperature and have melting points above about 40° C.

Again, fast cure is achieved by the combined epoxy functionality of the epoxy plus the carboxylic acid functionality of the polyester being preferably at least 7, more preferably at least 10, most preferably at least 12.

A curing agent is typically incorporated in the coating powder of this invention to crosslink the epoxy resins at the epoxy sites and provide the desired thermoset properties to the coating, although it is possible to cure the coating without a curing agent. The curing agents useful herein are preferably solid materials having at least two functional groups reactive with the epoxy groups. Examples of suitable curing agents include, without limitation, dicyanodiamine, bisphenol A, bisphenol S, bisphenol A epoxy adduct of an aliphatic polyamine having a primary or secondary amino group, with dicyanodiamide being preferred. Generally, the curing agent is used in an amount of 0.7-1.7 equivalents, preferably 1.1-1.4 equivalents of the functional group per one equivalent of the epoxy group present in the powder coating composition. Typically, this translates to a range of about 3 to 7 phr of curing agent in the coating powder composition, preferably about 4.5 to 5.5 phr. The term “phr” used herein is a weight measurement (parts per hundred resin) which relates to the total amount of the resin system of the coating powders, the resin system comprising the polyester resin A) plus the epoxy B) (100 parts total).

Although it is possible to cure or crosslink the coating powder without the use of catalysts, it is usually desirable to employ a cure catalyst in the powder coating composition of this invention to permit the curing reaction to progress at commercially acceptable rates. The cure catalysts useful herein are preferably solid materials known to promote an epoxy ring opening function and the formation of ether linkages between epoxy resins. Particularly preferred catalysts include, without limitation, 2-methyl imidazole, 2-phenyl imidazole, as well as bisphenol A epoxy adducts of the aforementioned imidazoles if lower temperatures/faster cures are desired. Generally, the amount of catalysts employed in the powder coating ranges from about 0.01 to 0.3 phr, preferably about 0.05 to 0.1 phr.

The coating powder may be clear, i.e., non-pigment-loaded, or may contain up to 200 wt % (200 phr) (though generally 120 wt % (120 phr) or less) of filler and/or pigment. In addition, the coating powder may contain conventional additives, e.g., antioxidants, light stabilizers, flow modifiers, co-stabilizer, etc., generally at a total level of about 10 phr or less.

Coating powders in accordance with the present invention are formed in a conventional manner. The components of the coating powder are combined and blended for not more than 15 minutes, to blend well. The blended materials are then extruded, typically in the range of 70-150° C. in a single screw (or twin screw extruder, allowed to cool, chipped ground and screened to obtain a powder of appropriate particle size. Average particle size is typically 20-80 microns. Scalping at 100 mesh is typical to remove coarse particles. There is typically about 10% by weight of particles below 10 microns. The amount of material retained on a 325 mesh is typically between about 30 and 50 wt. %. The coating powder is then applied in a conventional manner, e.g., electrostatically, to a substrate. For purposes of the invention, electrostatic application of coating powder includes conventional methods, such as corona-discharge methods and tribocharging methods. The intermediate coated substrate is heated at the time of application and/or subsequently so that the coating particles melt, form a continuous film, and cure.

The coatings are applicable to substrates, such as metal, e.g., steel or aluminum, or various polymers. In addition, as one aspect of the invention, by addition of a suitable catalyst, the cure temperature of the composition may be 350° F. (177° C.) or below and even 250° F. (121° C.) or below, temperatures consistent with application of the coating powder compositions to temperature-sensitive metals. Of course, cure is time-dependent as well as temperature dependent; however, a full cure must be achieved within a reasonable time. Thus, for purposes of this invention, a cure time of 15 minutes at the cure temperature to achieve a full cure is considered reasonable, and temperatures of at or below 350° F. (177° C.), preferably at or below 250° F. (121° C.), for 15 minutes to effect a full cure is considered acceptable for temperature-sensitive metal applications. A “full cure” is a degree of curing achieved at which additional time at elevated temperature will not improve the properties of the coating once cooled to ambient temperatures.

The coating powder compositions of this invention may be clear, i.e., unpigmented or unfilled, or contain standard pigments and fillers to impart the desired color and opacity to the coating film, although the benefits of this invention are most effectively achieved in clear formulations. By “clear”, it is meant that the powder coating composition is essentially free of opaque pigments and fillers, so that it will produce cured coating films that are essentially transparent. The thickness of the outer coating will vary, depending upon design, from 0.5 mil to 3.0 mil (12.7 to 76.2 micrometers), preferably 1.0 to 2.0 (25.4 to 50.8 micrometers) mil and, most preferably, 2.5 mil (63.5 micrometers).

In addition to the above components, the thermosetting coating powder composition of this invention may contain the usual additives such as, without limitation, standard dry flow additives, flow control agents, leveling agents, degassing agents, antioxidants, ultraviolet light absorbers, light stabilizers, and the like. Such additives are generally used in amount from 0.1 to 10 phr.

The cure temperatures of the above powders will vary somewhat depending on the various ingredients employed. However, it is particularly important that the coating powders possess the ability to cure at low temperatures without trapping bubbles within the cured coating film formed therefrom. Substrates susceptible to degradation upon heating, such as aluminum and brass parts, generally require a cure temperature of about 350° F. (177° C.) or less. In accordance therewith, it is preferred that the powder coating of this invention be formulated to cure to a thermoset state at temperatures of about 350° F. (177° C.) or less, preferably between about 325° F. (163° C.) and 350° F. (177° C.), within commercially reasonable times, e.g., 5 to 30 minutes or less, preferably 10 to 20 minutes or less, and, most preferably, 15 minutes, while still producing coating films having excellent adhesion.

Powder coatings of this invention are prepared in the usual manner. First, an intimate mixture is formed by dry blending together all of the formulation ingredients in a mixer. The dry blend is then melt-blended in a mixing extruder with heating above the melting point of the resin and other ingredients, where necessary, so ^{oo}that the extrudate is a thorough and homogeneous mixture. Extrusion is preferably carried out at temperatures either below or close to the Tm of the crystalline epoxy resin for efficient melt-processing and desired storage stability. Gaseous or supercritical fluid, e.g., CO₂, may be charged to the extruder for better control of the extrusion temperatures. Thereafter, the extruded composition is rapidly cooled and solidified and then broken into chips. Next, the chips are ground in a mill with cooling, and, as necessary, the particulates are screened and sorted according to size. Average particle size desired for electrostatic application is generally between about 20 and 60 microns. Once the dry, free-flowing, powders of this invention, which now contain at least one non-crystalline epoxy resin and at least one crystalline epoxy resin, are produced, they are ready for application onto a substrate to be coated.

The coating powder s of this invention can then be applied to the intermediate coated substrate by any conventional powder coating technique, although electrostatic application, e.g., electrostatic spraying, is generally preferred. In electrostatic spray coating, electrostatic spray booths are normally employed which house banks of corona discharge or triboelectric spray guns and a reclaim system for recycling the overspray powders into the powder feed. The substrate is heated, at least on the surface, at the time of application and/or subsequently to a temperature equal to or above the temperature needed to cure the powder coating and below the substrate outgassing and/or degradation temperature, so that the coating particles sufficiently melt, flow and form a smooth continuous coating film, and then cure to a thermoset state without degrading the substrate. Heating can be performed in infrared, convection ovens, or a combination of both, although infrared ovens are preferred. Time and temperature of the final cure will vary somewhat depending on the coating powders employed and conditions of use. However, regardless of cure time and temperatures employed, provided that the powder ingredients have been sufficiently melted before curing, the coating films generated on the substrates will have a visually consistent appearance and will be without entrapped bubbles that interfere with the aesthetic appearance and distinctness of image required by conventional standards.

The coating powder compositions are particularly suited for application onto temperature-sensitive metallic substrates, particularly brass, susceptible to tarnishing and/or degradation upon heating.

Some embodiments of the invention will now be described in greater detail by way of specific examples.

All polyethyleneimine solutions are adjusted to 1.0, 1.5, or 3.2, or 4.8% resin solids by addition of water. Polyimine baths are prepared by dissolving the polyethyleneimine in laboratory deionized water to give solutions containing 1.5% resin solids by weight. The baths are used at room temperature, without pH adjustment.

Brass substrates were cleaned and coated with the polyethyleneimine solutions by spraying. The substrate was then coated with a commercially available epoxy coating powder composition, and fused and cured according the manufacturer's directions. Degree of disbondment of the powder coating was checked using a hook knife at around the edges of the substrate, and by measuring the length of delamination at each site. Improved adhesion (as indicated by decreased debonding of the powder coating) was observed using 1.2%, 3.2%, and 4.8% polyethyleneimine coatings, compared to powder coatings applied in the absence of a polyethyleneimine coating. It was also found that use of thinner films in combination with the adhesion promoter led to decreased debonding.

What is claimed is:

1. A method for improving the adhesion of powder coatings on a metallic substrate, the method comprising:
applying polyalkyleneimine to a surface of the substrate to form an intermediate treatment layer on the substrate;
disposing a layer of a coating powder composition at least partially on the intermediate layer; and
fusing and curing the coating powder to form a powder coating.

2. A method as defined in claim 1 wherein the polyalkyleneimine is in a diluted by a solvent, and the intermediate treated substrate is heated to substantially remove the solvent.

3. A method as defined in claim 1 wherein the metallic substrate is selected from the group consisting of brass, aluminum, copper, silver, gold, and alloys comprising one or more of these.

4. A method as defined in claim 1 wherein the polyimine is a polyalkyleneimine having a monomeric unit structural formula of: 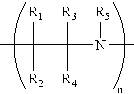
wherein n is a whole number and wherein R₁ through R₄ are each selected from the group consisting of hydrogen and lower alkyl groups, R₅ is selected from the group consisting of hydrogen, lower alkyl groups, hydroxy substituted lower alkyl group, lower alkyl alkoxy groups and fatty acid residues from the reaction of a fatty acid with the imine, the polyalkyleneimine having a molecular weight in excess of about 800.

5. A method as defined in claim 1 wherein the polyimine is selected from the group consisting of polyethyleneimine, polypropyleneimine, polybuteneimine, polyisobuteneimine, poly N-methyl ethyleneimine, poly N-(β-hydroxyethyl) ethyleneimine, poly N-(fatty acid) ethyleneimine, poly N-(ethylene oxide) ethyleneimine, and copolymers and quarternary ammonium salts thereof, all having a molecular weight in excess of about 800.

6. A method as defined in claim 1 wherein the intermediate treatment layer is continuous over the substrate.

7. A method as defined in claim 4 wherein the polyimine is polyethyleneimine.

8. A method as defined in claim 1 wherein the coating powder comprises an epoxy coating powder compostions.

9. A composite structure that comprises, in intimate adhesive contact,
a substrate;
an intermediate adhesion promoting layer comprising a polyalkyleneimine; disposed on a surface of the substrate; and
a powder coating disposed at least partially on the intermediate adhesion promoting layer on a side opposite the substrate.

10. A composite as defined in claim 10 wherein the substrate is selected from the group consisting of brass, aluminum, copper, silver, gold and alloys comprising one or more of these.

11. A composite as defined in claim 10 wherein the intermediate coating layer provides tarnish resistance.

12. A composite as defined in claim 10 wherein the intermediate treatment layer is continuous over the substrate
